(19) United States
(12) Patent Application Publication
(10) Pub. No.: US 2010/0198965 A1
(43) Pub. Date: Aug. 5, 2010

(54) NETWORK CONTROL DEVICE, IMAGE DISPLAY DEVICE AND NETWORK CONTROL METHOD

(76) Inventor: Takaharu Tanaka, Osaka (JP)

Correspondence Address: MCDERMOTT WILL & EMERY LLP, 600 13TH STREET, NW, WASHINGTON, DC, 20005-3096, US

(21) Appl. No.: 12/668,807

(22) PCT Filed: Jun. 20, 2008
(86) PCT No.: PCT/JP2008/001601

§ 371 Date: Jan. 12, 2010

(30) Foreign Application Priority Data
Jul. 13, 2007 (JP) 2007-184681

(51) Int. Cl. G06F 15/173

(52) U.S. Cl. 709/224; 709/233

(57) ABSTRACT

In order to easily ensure service quality by reducing network traffic, a network monitoring section (30) monitors a transfer rate (bit rate, bandwidth) of data which is transferred between each of the network-enabled devices connected through a LAN (100) and interne (110), and outputs the transfer rate, that is, network load information representing a network load, to a network QoS control section (31). The network QoS control section (31) determines whether a transfer is possible or not (whether a requested transfer rate is available or not) based on the network load information and the requested transfer rate requested from the network-enabled devices, etc.; and if it is determined that the requested transfer rate is not available, reduces an image in the transferred data in size; then, the data of reduced image is transferred. Thus, the transfer rate can be kept low.

### TECHNICAL FIELD

The present disclosure relates to network control devices which control data transfer, etc., in a network.

### BACKGROUND ART

In recent years, as network technologies have progressed, more network environments with bandwidths of 100 Mbps (megabits per second) are being built for wired networks even in home network infrastructures. Also in wireless networks, those that comply with IEEE 802.11a/g have 54 Mbps of bandwidths.

Meanwhile, as the number of home network-enabled devices increases, distribution of high quality and high definition videos such as HD (High Definition) videos, etc., which could not be realized in a narrow-band network environment with a conventional bandwidth of about 10 Mbps, is becoming widespread. In addition, since throughput of every network-enabled device has been dramatically increased, and an increasing number of video/audio data (A/V data, contents) streams can be managed simultaneously, distribution and reception of A/V data by a plurality of devices simultaneously through network access to/from one single device is also growing.

Therefore, traffic of a home network is constantly increasing, so even if the bandwidth of a network is broadened as mentioned above, real-time nature cannot necessarily be guaranteed in A/V data distribution, etc. (If real-time nature cannot be obtained, then in processing of A/V data streaming, for example, unwanted problems such as video disturbance or voice interruption will occur in consumer devices, etc.)

Thus, in network control devices such as conventional routers, etc., QoS (Quality of Service) control is performed. More specifically, one technology is known, for example, in which a traffic category is set in the header of a packet upon sending the packet, and a best-effort class and a real-time class of traffic categories are differentiated and controlled in routers according to the set traffic category, thereby assuring service quality (see, e.g., Patent Document 1).

### CITATION LIST

### Patent Document

PATENT DOCUMENT 1: Japanese Unexamined Patent Application Publication No. 2001-189754

### SUMMARY OF THE INVENTION

### Technical Problem

However, even if a best-effort class and a real-time class of traffic categories are differentiated and controlled accordingly as described above, there was a problem in that if, for example, the total transfer rate of the real-time class of A/V data, etc., is only slightly smaller than the bandwidth of a network, or even exceeds the bandwidth, then service quality cannot be ensured.

The present invention is created in view of the foregoing, and it is an object of the present invention to easily ensure service quality by reducing network traffic.

### Solution To The Problem

In order to solve the aforementioned problem,

the present invention is characterized in that

a network control device which controls service quality of transfer of audio/visual data through a network, includes

a transfer monitoring section configured to monitor the transfer of audio/visual data, and to output load information representing a network load,

a determination section configured to determine, based on the load information and a requested transfer rate requested from a device connected to the network, whether a transfer at the requested transfer rate is possible or not, and

a conversion section configured to convert the transferred audio/visual data so that the transfer rate of the transferred audio/visual data is reduced, if it is determined by the determination section that the transfer is not possible.

As a result, when the network bandwidth does not have a sufficient margin, for example, the transfer rate required for transferring audio/visual data is reduced by conversion of the audio/visual data by the conversion section.

### Advantages of the Invention

According to the present invention, service quality is easily ensured by reducing network traffic.

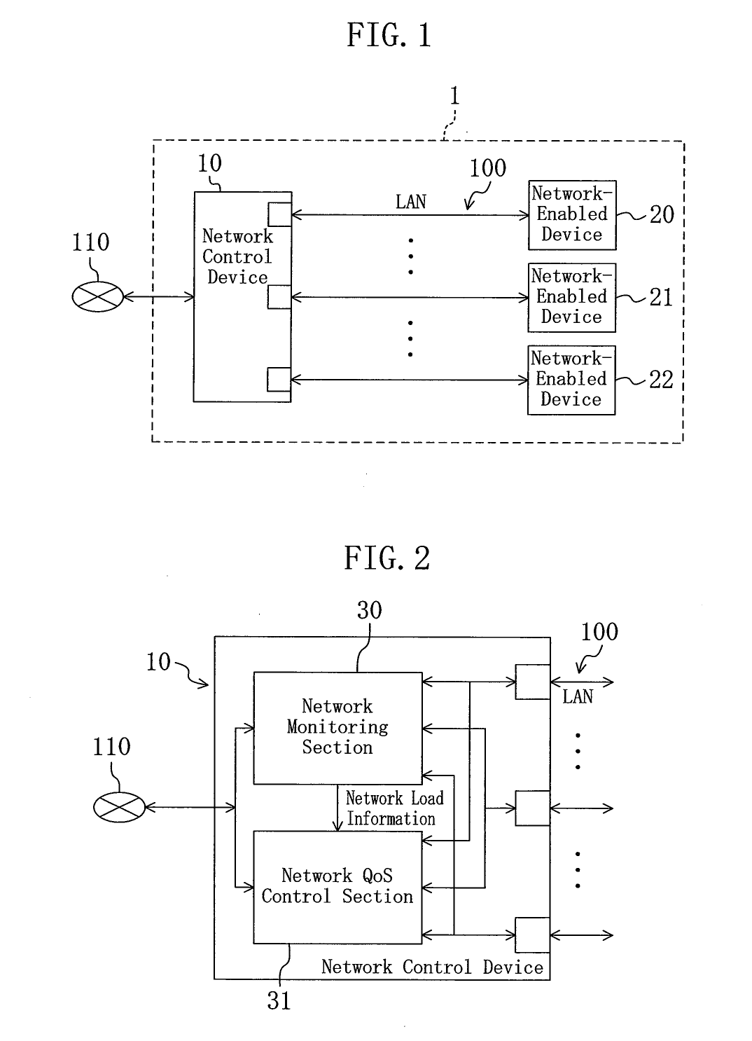

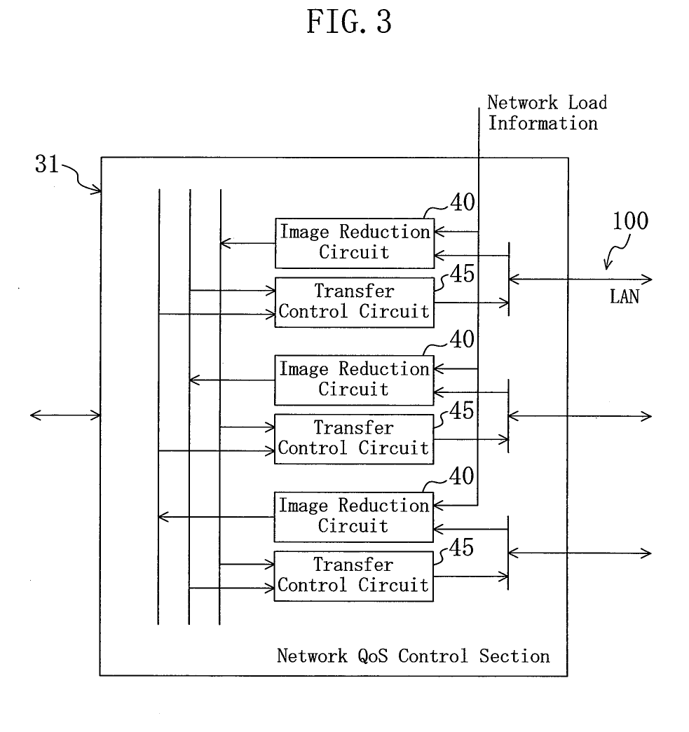

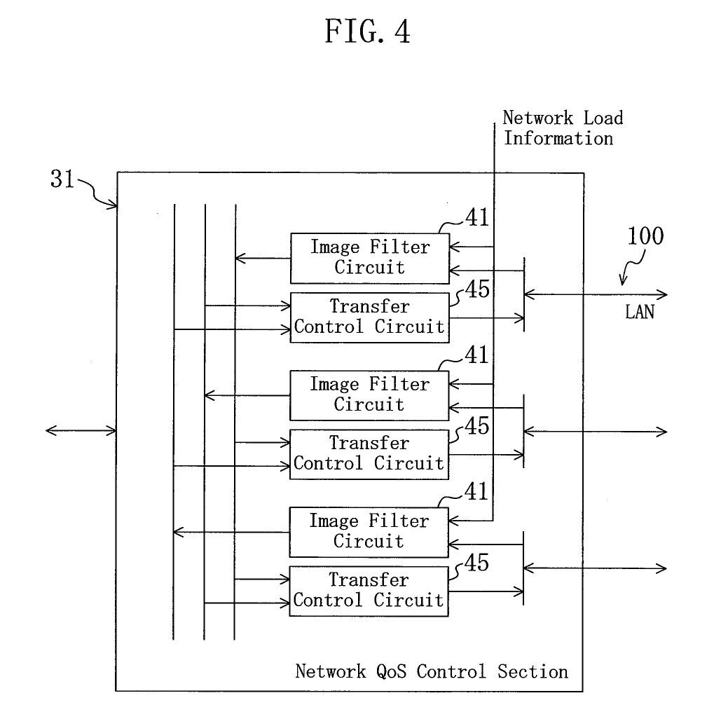

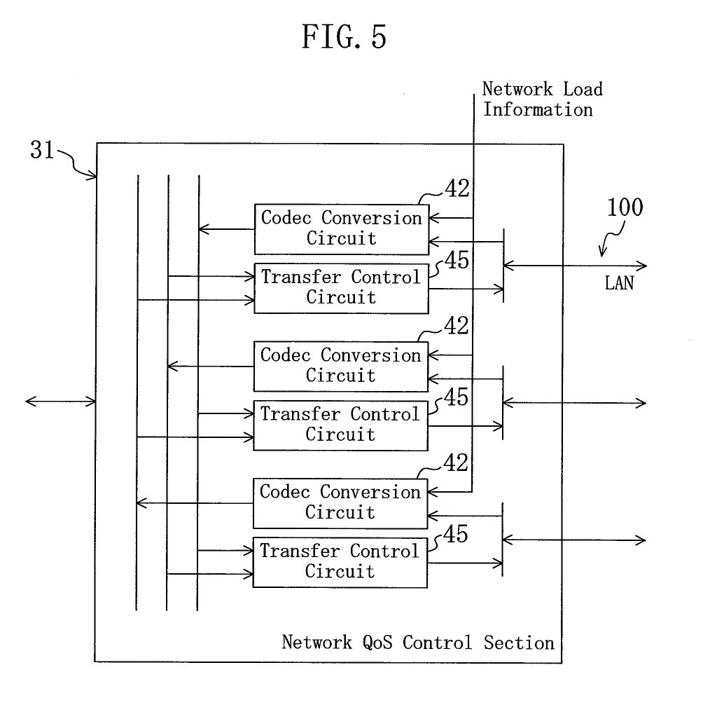

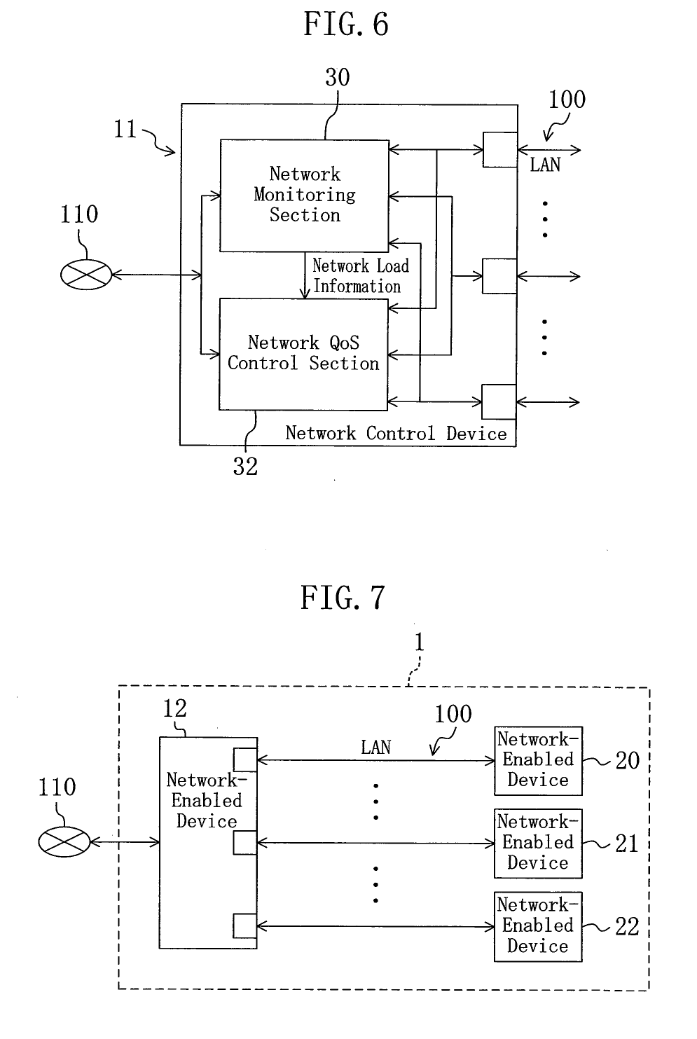

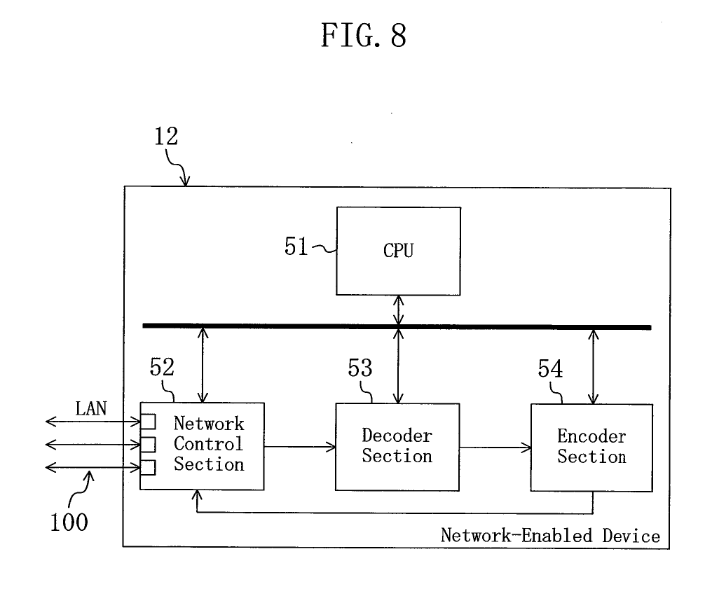

### BRIEF DESCRIPTION OF THE DRAWINGS

[FIG. 1] FIG. 1 is a block diagram illustrating a configuration of the network system 1 including the network control device 10 in accordance with the embodiment 1.

[FIG. 2] FIG. 2 is a block diagram illustrating a configuration of the network control device 10 in accordance with the same. [FIG. 3] FIG. 3 is a block diagram illustrating a configuration of the network QoS control section 31 in accordance with the same.

[FIG. 4] FIG. 4 is a block diagram illustrating another configuration of the network QoS control section 31 in accordance with the same.

[FIG. 5] FIG. 5 is a block diagram illustrating yet another configuration of the network QoS control section 31 in accordance with the same.

[FIG. 6] FIG. 6 is a block diagram illustrating a configuration of the network control device 11 in accordance with the embodiment 2.

[FIG. 7] FIG. 7 is a block diagram illustrating a configuration of the network system 1 including the network-enabled device 12 having a function as a network control device in accordance with the embodiment 3.

[FIG. 8] FIG. 8 is a block diagram illustrating a configuration of the network-enabled device 12 in accordance with the same.

### DESCRIPTION OF EMBODIMENTS

Example embodiments of the present invention will be described below in detail with reference to the drawings, where a same symbol is used for a component having a similar function to that of other embodiments, and the explanation thereof will be omitted.

### Embodiment 1 of the Invention

As shown in FIG. 1, a network system 1 is configured such that a network control device 10 is connected with a plurality of network-enabled devices 20-22 (e.g., a personal computer, a hard disk recorder, a television receiver, etc.) through a LAN 100, and also with internet 110; and communication is made between each of the network-enabled devices 20-22 and the internet 110, and among the network-enabled devices 20-22, through the network control device 10. Here, as for the LAN 100, there is no specific limitation on the form of whether it is wireless or wired, or on the transfer method. That is, communication in compliance with Ethernet (a registered trademark), optical communication, or power line communication may be applied, and cable connection which is capable of transferring other video, audio, and other data, and which supports an interface standard typified by HDMI (High-Definition Multimedia Interface), IEEE 1394, etc., may be used.

The network control device 10 is designed to have, for example, a function of a router and a function of a switching hub (a LAN switch), and to perform priority control and/or bandwidth control of transferred data by constantly monitoring a network load. In more detail, as shown in FIG. 2 for example, the network control device 10 includes a network monitoring section 30 and a network QoS control section 31.

The network monitoring section 30 is designed to monitor a transfer rate (bit rate, bandwidth) of data which is transferred between each of the network-enabled devices 20-22 and the internet 110, and to output the transfer rate, that is, network load information representing the network load, to the network QoS control section 31.

The network QoS control section 31 is designed to determine whether a transfer is possible or not, that is, whether the requested transfer rate is available or not based on the network load information and, for example, the requested transfer rate requested from any of the network-enabled devices 20-22, etc., of a data distribution or reception side. More specifically, it is determined, for example, whether or not the sum of a current transfer rate indicated by the network load information, and the requested transfer rate exceeds a transfer rate at which a transfer is possible to/from each of the network-enabled devices 20-22, etc., (e.g., a physical maximum rate, a maximum rate with an effective performance taken into account, a rate including a predetermined margin, etc.). Note that the above-mentioned decision may be made only at the start of a transfer when a transfer request is made by any of the network-enabled devices 20-22, etc., or may also be made during a transfer process, for example, every predetermined time interval. In the latter case, if a margin of the transfer rate becomes large enough during a transfer, degraded image quality can be restored by stopping an image reduction process, which will be described below, or by reducing the degree of image reduction.

As shown in FIG. 3 for example, the network QoS control section 31 also includes an image reduction circuit 40 and a transfer control circuit 45. The image reduction circuit 40 is designed to reduce an image in transferred data in size, if the transferred data is image data and it is determined that the requested transfer rate is not available. The transfer control circuit 45 is designed to perform transfer control such as to hold the transferred data in a queue tentatively and to send the transferred data at a predetermined time depending on a priority. Here, it is designed such that an image reduced in size by the image reduction circuit 40 is restored to an original image size by, for example, an image enlargement circuit (not shown) of each of the network-enabled devices 20-22 receiving the image data, based on information representing an image reduction factor (or information representing a transfer rate based thereon, etc.) notified of from the network QoS control section 31 to the network-enabled devices 20-22. Also, if image size reduction, etc., is performed, users may be notified of its execution or, for example, a possibility that a degradation in image quality may occur by, for example, displaying on any of the network-enabled devices 20-22 accordingly. In addition, depending on the display, etc., a user may be asked for confirmation of, for example, whether the user want to have the image data transferred even if such reduction of the image size, etc., will be performed, or to suspend the transfer, and whether image reduction, etc., will be actually performed or not may be controlled accordingly. Moreover, in an initialization process, etc., whether such notification or confirmation is performed or not may be configured, or configuration may be allowed to be made such that a notification or confirmation is performed only when image reduction is performed to a higher degree than a predetermined degree.

In a network control device thus configured, the network QoS control section 31 determines whether the requested transfer rate from any of the network-enabled devices 20-22 is available or not when data transfer is requested from any of the network-enabled devices 20-22 of the distribution side. If it is determined that the requested transfer rate is available, then a data transfer similar to that of a general network control device is performed. Meanwhile, if it is determined that the requested transfer rate is not available, then the image reduction circuit 40 reduces an image in the transferred data in size, and the reduced image data is transferred. Therefore, the transfer rate is kept low, and the network load is reduced. Here, the image reduction factor may be as large a reduction factor as possible within a range where the actual transfer rate is equal to or less than the transferable transfer rate, or may be a preset reduction factor, for example.

Here, the way in which a transfer rate is requested from any of the network-enabled devices 20-22 is not particularly limited; a request may be made, for example, using a procedure in which the requested transfer rate and information indicating the start of a transfer at that transfer rate is set in the header of a first block of transferred data, and information indicating the end of the transfer at that transfer rate is set in the header of a last block of transferred data.

As described above, when, for example, the network bandwidth has a small margin only, reducing an image size and thereby transferring with a required bandwidth kept small allows for a limited network bandwidth to be used efficiently, and then practical service quality (real-time nature) is ensured. Also, since reduction of an amount of data reduces the size of a unit of bandwidth control process, flexible and reliable bandwidth control is facilitated. Therefore, a network control device as described above is preferred in cases where, for example, application software which uses a broad bandwidth sends and/or receives contents requiring real-time nature through a network.

Note that, although a case is described in the above example where the network QoS control section 31 determines whether a requested transfer rate is available or not based on the requested transfer rate requested from any of the network-enabled devices 20-22, etc., the requested transfer rate does not necessarily need to be indicated directly from any of the network-enabled devices 20-22, etc., but the requested transfer rate may be indicated indirectly by information with which a transfer rate can be identified, such as a requested image size (e.g., 1920×1080 pixels), a requested number of frames per unit time (e.g., 30 frames per second), and a requested codec information (e.g., H.264).

### Variation of Embodiment 1 of the Invention

In order to reduce a transfer rate, not only reduction of an image size, but also various methods for reducing data size are applicable. For example, as shown in FIG. 4, an image filter circuit 41 may be provided instead of the image reduction circuit 40, and a frame rate may be reduced by, for example, converting images of a progressive format to those of an interlaced format.

Alternatively, as shown in FIG. 5 for example, a codec conversion circuit 42 may be provided and may re-encode using a codec producing a lower bit rate, such as conversion from MPEG2 to H.264.

In addition, these may be performed selectively or in combination.

### Embodiment 2 of the Invention

A network control device in accordance with the embodiment 2 is designed such that when it is determined that a transfer rate requested from a network-enabled device is not available, a user can select whether to perform a reduction of an image size, etc., (i.e., to take priority on an immediate start of transferring even if a degradation in image quality, etc., would occur), or to wait until the transfer rate will become available and then to start transferring (i.e., to take priority on not degrading the image quality even if a start of transferring is delayed).

More specifically, as shown in FIG. 6 for example, a network control device 11 in accordance with the embodiment 2 includes a network QoS control section 32 instead of the network QoS control section 31 of the embodiment 1.

The network QoS control section 32 is designed such that a user can specify in advance a selection of whether to take priority on a quick start of transferring, or to take priority on an image quality when a transfer rate is not available. (The above-mentioned designation can be designed to be done, for example, by an operation of any of the network-enabled devices 20-22 of the reception side, etc., using a graphical user interface. In addition, the selection procedure is not limited to the one in which the above designation is made in advance, but may be such that when it is detected that a transfer rate is not available at a start of transferring (playback), the network QoS control section 32 notifies the user and receives its choice. Furthermore, even when a designation is made in advance, the designation may be made corresponding to, for example, each genre of contents, each device of the distribution side, etc.)

Also, the network QoS control section 32 is designed to determine, when a data transfer is requested from any of the network-enabled devices 20-22, whether the requested transfer rate is available or not in a similar way to that of the embodiment 1, and if it is determined that the requested transfer rate is not available, to perform a process as follows according to the user selection described above.

That is, when priority is taken on a quick start of transferring, a transfer at a reduced transfer rate is started by performing a reduction of an image size in the transferred data, a reduction of a frame rate, codec conversion, etc., again in a similar way to that of the embodiment 1.

Alternatively, when priority is taken on an image quality, a waiting time until a transfer at the requested transfer rate will become available (information corresponding to the waiting time) is obtained, and a reservation is made to secure a transfer bandwidth after the waiting time. In addition, in response to a transfer request from any of the network-enabled devices 20-22, the waiting time as well as information representing an error are returned to the network-enabled devices 20-22, and a transfer is requested again after the waiting time has elapsed. Moreover, a user may be notified of the waiting time, for example, by displaying the waiting time on a display section (not shown) of any of the network-enabled devices 20-22.

In a network control device thus configured, when a data transfer is requested from any of the network-enabled devices 20-22 of the distribution side, and the network QoS control section 32 determines whether the requested transfer rate is available or not, and if it is determined that the requested transfer rate is available, then a data transfer similar to that of a common network control device is performed.

Meanwhile, when it is determined that the requested transfer rate is not available, and if priority is selected to be taken on a quick start of transferring, then data transfer is performed at a transfer rate reduced by means of an image size reduction, etc., in a similar way to that of the embodiment 1.

Alternatively, when it is determined that the requested transfer rate is not available, and if priority is selected to be taken on an image quality, then the network QoS control section 32 obtains a waiting time until a transfer at the requested transfer rate will become possible, and reserves a transfer bandwidth so that the transfer bandwidth is secured after this waiting time. In addition, in response to a transfer request from any of the network-enabled devices 20-22, the waiting time as well as information representing an error are returned to the network-enabled devices 20-22. Thus, since the network QoS control section 32 can secure the transfer bandwidth when a transfer is requested again from any of the network-enabled enabled devices 20-22 after the waiting time has elapsed, data transfer at the requested transfer rate is performed by the network-enabled devices 20-22.

### Embodiment 3 of the Invention

A network control device is not limited to an independent device as described above, but may be one such as a network-enabled device 12 integrated with a function as a network control device as shown in FIG. 7. More specifically, this network-enabled device 12 is, for example, a television receiver or a digital A/V (Audio Visual) device such as a DVD (Digital Versatile Disk)/hard disk recorder, which is used as a network control device similar to the network control device 10 of the embodiment 1, thus constituting a network system 1.

As shown in FIG. 8 for example, the network-enabled device 12 includes a high-performance CPU (Central Processing Unit) 51, a network control section 52, a decoder section 53, and an encoder section 54.

The decoder section 53 and the encoder section 54 have compression and expansion functions of codec to operate as a digital A/V device, as well as functions of transfer rate conversion and/or codec conversion of data transferred through the network control section 52.

Also, the network control section 52 has, for example, at least a router function and a switching hub function. In more detail, although the network control section 52 has a function similar to that of the network control device 10 of the embodiment 1, the network control section 52, instead of including the codec conversion circuit 42, instructs the decoder section 53 and the encoder section 54 to re-encode using a codec producing a lower bit rate, such as conversion from MPEG2 to H.264, etc.

Here, the network control section 52, the decoder section 53, and the encoder section 54 may be configured mainly with hardware, or may be configured with CPU 51 and software.

Operation of the network-enabled device 12 as a network control device is similar to that of the network control device 10 of the embodiment 1, except that the network control section 52 allows the decoder section 53 and the encoder section 54 to perform codec conversion. That is, when a requested transfer rate requested from any of the network enabled devices 20-22 is not available, codec conversion is performed, and by transferring with the required bandwidth kept small, practical service quality is ensured.

Note that not only codec conversion, but also a reduction of an image size, a reduction of a frame rate, or a combination thereof, etc., may be performed. In addition, it may be designed to be selectable whether priority is taken on a quick start of transferring, or priority is taken on image quality, in a similar way to that of the embodiment 2.

Meanwhile, the network-enabled devices 12 and 20-22 described in each of the above embodiments are not limited to those described above, but may be, for example, video recorder/playback devices each with a storage medium such as a network-accessible DVD, BD (Blu-ray Disc), HD-DVD (High Definition DVD), hard disk, or any of various memory cards including an SD (Secure Digital) memory card, or may be network-accessible network terminals, digital television receivers, set-top boxes, digital still cameras, digital video cameras, PDAs (Personal Digital Assistants), mobile phones, personal computers, etc., or so-called information white goods such as network-accessible refrigerators or washing machines, and may not even be specifically limited to home appliances.

Moreover, the network control device 10, etc., is not limited specifically to a device having a router function and a switching hub function, but may be any device which controls data transfer, etc., in a network.

Also, the components described in each of the above embodiments may be combined in various ways as far as it is logically possible, including any variation thereof.

### INDUSTRIAL APPLICABILITY

A network control device in accordance with the present invention has an advantage in that service quality can be easily ensured by reducing network traffic, and is useful as a network control device, etc., which controls data transfer, etc., in a network.

### DESCRIPTION OF REFERENCE CHARACTERS

1 Network System
10, 11 Network Control Device
12 Network-Enabled Device
20-22 Network-Enabled Device
30 Network Monitoring Section
31, 32 Network QoS Control Section
40 Image Reduction Circuit
41 Image Filter Circuit
42 Codec Conversion Circuit
45 Transfer Control Circuit
51 CPU
52 Network Control Section
53 Decoder Section
54 Encoder Section
100 LAN
110 Internet

1. A network control device which controls service quality of transfer of audio/visual data through a network,
the network control device also serving as an audio/visual data processing device which performs at least one of display, recording, playback, and broadcast reception of audio/visual data comprising:
a transfer monitoring section configured to monitor the transfer of audio/visual data, and to output load information representing a network load;
a determination section configured to determine, based on the load information and a requested transfer rate requested from a device connected to the network, whether a transfer at the requested transfer rate is possible or not; and
a conversion section configured to convert the transferred audio/visual data so that the transfer rate of the transferred audio/visual data is reduced, if it is determined by the determination section that the transfer is not possible, and to convert audio/visual data in audio/visual data processing in order to perform display, recording, playback, or broadcast reception of the audio/visual data.

2. The network control device of claim 1, wherein
the conversion section performs at least one of
conversion to reduce an image size in the transferred audio/visual data,
conversion to reduce a frame rate in the transferred audio/visual data, and
re-encoding according to a compression method which is more compressive than an original compression method.

3. The network control device of claim 1, wherein
the network control device is configured to notify the device connected to the network, of information which depends on the reduction of the transfer rate by the conversion section.

4. The network control device of claim 3, wherein
the conversion section is configured such that whether the transfer rate is reduced or not is controlled depending on an instruction from the device notified of the information which depends on the reduction of the transfer rate.

5. The network control device of claim 1, further comprising:
a wait-for-transfer control section configured to perform control operations of obtaining a waiting time until a transfer at the requested transfer rate will become available, notifying the device which has requested the transfer, of the waiting time, and reserving a transfer bandwidth after the waiting time,
wherein
if it is determined by the determination section that the transfer is not possible, at least one of the conversion by the conversion section and the control by the wait-for-transfer control section is performed.

6. The network control device of claim 5, wherein
in response to a selection instruction from the device connected to the network in advance, at least one of the conversion by the conversion section and the control by the wait-for-transfer control section is performed.

7. (canceled)

8. (canceled)

9. An image display device which has a function to manage transferring of audio/visual data with another device by requesting to the network control device of claim 4 a transfer of audio/visual data, configured to display information concerning reduction of a transfer rate on an image display section, in response to the information based on the reduction of the transfer rate, which has been notified of from the network control device, and to instruct the network control device whether to reduce the transfer rate or not, in response to a user operation.

10. An image display device which has a function to manage transferring of audio/visual data with another device by requesting to the network control device of claim 5 a transfer of audio/visual data, configured to display on an image display section the waiting time until a transfer at the requested transfer rate, which has been notified of by waiting control of the wait-for-transfer control section, will become available.

11. A network control method executed by a device serving a dual purpose of a network control device which controls service quality of transfer of audio/visual data through a network, and
an audio/visual data processing device which performs at least one of display, recording, playback, and broadcast reception of audio/visual data, comprising:
a transfer monitoring step of monitoring the transfer of audio/visual data and outputting load information representing a network load;
a determination step of determining, based on the load information and a requested transfer rate requested from a device connected to the network whether a transfer at the requested transfer rate is possible or not; and
a conversion step of converting the transferred audio/visual data using a conversion section configured to convert the transferred audio/visual data so that the transfer rate of the transferred audio/visual data is reduced, if it is determined by the determination step that the transfer is not possible, and to convert audio/visual data in audio/visual data processing in order to perform display, recording, playback, or broadcast reception of the audio/visual data.
